(19) United States
(12) Patent Application Publication
(10) Pub. No.: US 2024/0014765 A1
(43) Pub. Date: Jan. 11, 2024

(54) PARAMETER SETTING DEVICE FOR SETTING PARAMETER OF ELECTRIC MOTOR MODEL

(71) Applicant: FANUC CORPORATION, Yamanashi (JP)

(72) Inventor: Yohei KAMIYA, Yamanashi (JP)

(21) Appl. No.: 18/042,776

(22) PCT Filed: Oct. 13, 2021
(86) PCT No.: PCT/JP2021/037952

§ 371 Date: Feb. 24, 2023

(30) Foreign Application Priority Data
Oct. 20, 2020 (JP) 2020-176294

(51) Int. Cl. H02P 29/64; H02P 29/66

(52) U.S. Cl. CPC H02P 29/64; H02P 29/662

(57) ABSTRACT

In the present invention, an electric motor model comprises: a model of a coil of a stator; and a model of a temperature detector for detecting the temperature of the coil. A parameter such as a thermal capacity is included in the electric motor model. Provided is a parameter setting unit comprising a parameter calculation unit that calculates a parameter so that a change in the temperature of the model of the temperature detector corresponds to a change in the actual temperature. The parameter calculation unit includes an evaluation unit that evaluates the temperature of the model of the temperature detector, the temperature having been calculated using the temporarily set parameter. The evaluation unit evaluates the temperature of the model of the temperature detector without evaluating any variables besides the temperature of the model of the temperature detector.

### TECHNICAL FIELD

The present invention relates to a parameter setting device for setting a parameter of a model for an electric motor.

### BACKGROUND ART

In general, it is known that the temperature of an electric motor rises when driven. When the temperature of an electric motor becomes too high, the electric motor may not operate correctly or component members may be damaged.

The actual temperature when an electric motor is driven can be detected by a temperature detector attached to a component member. Alternatively, in the related art, a simulation device for estimating the temperature of a machine is known. An operator generates a computer aided design (CAD) model for a machine and sets material properties, heat transfer properties, or the like for the component members. The temperature of each component member can then be estimated by a finite element method or the like that performs calculations for each minute region of a device (e.g., see JP 2020-12654 A).

However, the material properties and the heat transfer properties of the component member depend on the surface properties of the component member. Thus, there is a problem that it is difficult for an operator to input accurate values. Further, there is a problem that it is difficult to predict the temperature with sufficient accuracy. In addition, the finite element method can make the regions small, into which the component member is divided, in order to improve the accuracy of temperature estimation. However, the smaller the regions into which the component member is divided, the greater the computational complexity for calculating heat transfer.

For estimating the temperature of a machine, it is known to use a thermal model that considers the heat capacities of the component members and the heat transfers between the component members (e.g., see JP 2014-36475 A, JP 2016-55657 A, and JP 2018-527019 A). In the thermal model, the temperature of each component member can be calculated by setting a heat transfer coefficient or a thermal resistance between each other of the component members and calculating heat transfers between the component members.

Also in an electric motor, there is known a device that estimates a temperature when the electric motor is driven by using a thermal model including a stator core, a coil, a rotor core, and the like (e.g., JP 2008-109816 A).

### CITATION LIST

### Patent Literature

Patent Document 1: JP 2020-12654 A
Patent Document 2: JP 2014-36475 A
Patent Document 3: JP 2016-55657 A
Patent Document 4: JP 2018-527019 A
Patent Document 5: JP 2008-109816 A

### SUMMARY OF INVENTION

### Technical Problem

When an electric motor is driven, heat is generated in the stator core, the coil fixed to the stator core, the bearing, and the like. Among them, the temperature of the coil formed by the winding wound around the stator core may be the highest. The temperature detector for detecting the temperature of the electric motor can, for example, be arranged so as to detect the temperature of the coil.

The controller of an electric motor can determine that the electric motor is overheated when the temperature output by the temperature detector is higher than a temperature determination value. In this case, the operating state of the electric motor cannot be maintained. The controller performs control of stopping the electric motor or reducing the rotation speed of the electric motor.

In a machine including an electric motor, it is preferable to perform a simulation in which the machine is driven in a desired operating pattern, thereby estimating whether the operating pattern is allowable. By estimating change in the temperature of the electric motor according to the operating pattern, the operating state of the electric motor can be determined. Alternatively, when the temperature of the electric motor becomes excessive, the operator can change the operating pattern of the machine. That is, the operator can generate the operating pattern of the machine so as to prevent overheating of the electric motor. As described above, it is preferable that the operator can determine whether the electric motor can be normally operated without actually driving the machine.

### Solution to Problem

A parameter setting device according to an aspect of the present disclosure sets parameters included in a model for an electric motor, the model for an electric motor being configured to estimate a temperature of a temperature detector that detects a temperature of one component constituting the electric motor. The parameter setting device includes a state acquiring unit configured to acquire an operation command for the electric motor generated by actually driving the electric motor and a temperature output from the temperature detector. The parameter setting device includes a parameter calculating unit configured to calculate the parameters in a manner that a change in a temperature of a model for the temperature detector calculated by the model for the electric motor corresponds to an actual change in temperature of the temperature detector. The model for the electric motor includes a model for a rotor, a model for a stator core, a model for a coil, and the model for the temperature detector, as models for components of the electric motor. The parameters include a heat capacity that is set for each model for the components and a heat transfer-related coefficient that is set between each two of the models for the components. The parameter calculating unit includes a loss calculating unit configured to calculate a heat generation amount due to a primary copper loss of the coil and a heat generation amount due to an iron loss of the stator core, based on the operation command. The parameter calculating unit includes a temperature calculating unit configured to calculate the temperature of the model for the temperature detector by using the model for the electric motor based on the heat generation amount of the coil and the heat generation amount of the stator core. The parameter calculating unit includes an evaluation unit configured to evaluate the temperature of the model for the temperature detector by comparing the temperature of the model for the temperature detector with the temperature of the temperature detector acquired by the state acquiring unit. The parameter calculating unit includes a parameter change unit configured to change values of the parameters based on a result of the evaluation by the evaluation unit. The evaluation unit evaluates the temperature of the model for the temperature detector without evaluating variables other than the temperature of the model for the temperature detector.

### Advantageous Effect of the Invention

According to an aspect of the present disclosure, a parameter setting device for setting a parameter of a model for an electric motor, which is configured to estimate temperature of a component member of an electric motor, can be provided.

### BRIEF DESCRIPTION OF DRAWINGS

FIG. 1 is a block diagram of a machine and a temperature estimator according to an embodiment.

FIG. 2 is a schematic cross-sectional view of a first electric motor according to an embodiment.

FIG. 3 is a model for the first electric motor according to an embodiment.

FIG. 4 is a graph illustrating a first operating pattern of an electric motor when setting parameters in the model for the electric motor.

FIG. 5 is a graph illustrating a second operating pattern of an electric motor when setting parameters in the model for the electric motor.

FIG. 6 is a model for a second electric motor according to an embodiment.

FIG. 7 is a first graph illustrating a current flowing through the second electric motor.

FIG. 8 is a second graph illustrating a current flowing through the second electric motor.

FIG. 9 is a graph of simulation results using parameters set in a parameter setting unit.

FIG. 10 is a graph illustrating a relationship between the temperature of a rotor and coefficient for correcting iron loss.

FIG. 11 is a graph illustrating a relationship between the temperature of a coil and the primary resistance.

FIG. 12 is a graph illustrating a relationship between the temperature difference between components and a constant for correcting a heat transfer-related coefficient.

FIG. 13 is a graph illustrating a relationship between the temperature and a constant for correcting the heat capacity, of a component.

### DESCRIPTION OF EMBODIMENTS

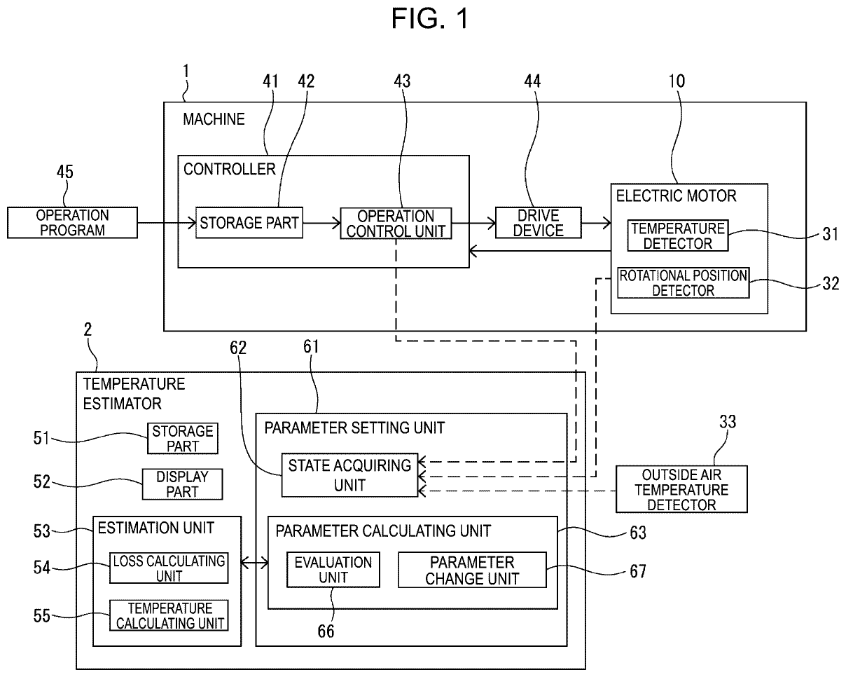

A parameter setting device for setting a parameter of a model for an electric motor used for a temperature estimator according to an embodiment, will be described with reference to FIGS. 1 to 13. When an electric motor is driven, the temperatures of the components constituting the electric motor rise. A temperature estimator according to the present embodiment estimates the temperature output by a temperature detector attached to one component included in the electric motor. In the present embodiment, an example of estimating the temperature output by a temperature detector that detects the temperature of a stator coil, which is one component of the electric motor, will be described. In this case, the temperature detector is attached to a coil fixed to the stator core.

The temperature estimator uses the model for the electric motor and estimates the temperature of the temperature detector. The model for the electric motor according to the present embodiment is a thermal model that expresses the transfer of heat between the components. A parameter setting device according to the present embodiment sets parameters such as heat capacities of the components and heat transfer-related coefficients between the components in the model for the electric motor. As heat transfer-related coefficient, heat transfer coefficient, or coefficient acquired by multiplying heat transfer coefficient by the contact area between the components, or the like, can be adopted.

FIG. 1 is a block diagram of: a machine according to the present embodiment; and a temperature estimator for estimating the temperature output from a temperature detector of an electric motor. A machine 1 according to the present embodiment is provided with an electric motor 10 for driving the components of the machine 1 and a controller 41 for controlling the electric motor 10. The controller 41 according to the present embodiment is composed of an arithmetic processing device (computer). The controller 41 includes a central processing unit (CPU) as a processor. The controller 41 includes a random access memory (RAM), a read only memory (ROM), or the like, connected to the CPU via a bus.

The machine 1 according to the present embodiment is a numerical control machine. The machine 1 is driven based on command statements described in an operation program 45. The operation program 45 is pre-generated by an operator. The controller 41 includes a storage part 42 that stores the operation program 45 and an operation control unit 43 that generates operation commands for the electric motor 10 based on the operation program 45. The machine 1 includes a drive device 44 including an electrical circuit that supplies electricity to the electric motor 10 based on the operation commands generated in operation control unit 43. The electric motor 10 is driven by the drive device 44 supplying electricity.

The storage part 42 can be composed of non-transitory storage media that can store information, such as a volatile memory, a nonvolatile memory, or a hard disk. The operation control unit 43 corresponds to a processor driven according to the operation program 45. The processor reads the operation program 45 and acts as the operation control unit 43 by performing the controls specified in the operation program 45.

Such a machine 1 can be any machine with the electric motor 10. As the machine 1, a machine tool for machining a workpiece can be exemplified. As the electric motor 10, a spindle axis motor for rotating a tool or a workpiece, or a feed axis motor for moving a table or a spindle head along a predetermined coordinate axis can be exemplified.

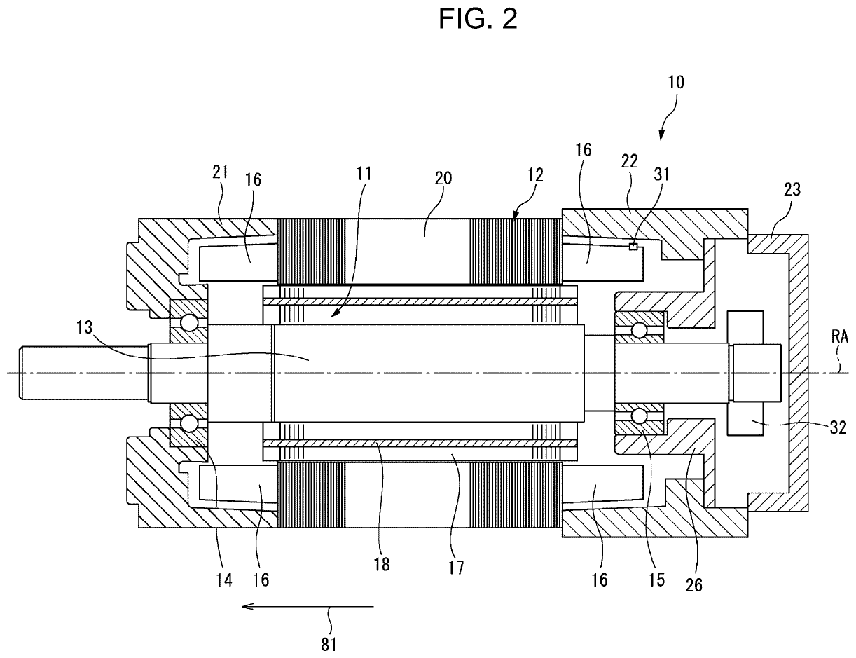

FIG. 2 is a cross-sectional view of a first electric motor according to the present embodiment. Referring to FIGS. 1 and 2, a first electric motor 10 is a synchronous motor in which a rotor 11 includes a magnet 18. The electric motor 10 includes the rotor 11 and a stator 12. The stator 12 includes a stator core 20 formed of a magnetic material and a coil 16 fixed to the stator core 20. The stator core 20 is formed of, for example, multiple magnetic steel plates stacked in the axial direction. The coil 16 includes, for example, a winding wound around the stator core 20 and a resin part for fixing the winding.

The rotor 11 is fixed to a rod-shaped shaft 13. The rotor 11 includes a rotor core 17 fixed to the outer circumferential surface of the shaft 13 and formed of a magnetic material, and a plurality of magnets 18 fixed to the rotor core 17. The magnet 18 according to the present embodiment is a permanent magnet.

The shaft 13 is connected to another member in order to transmit rotational force. The shaft 13 rotates around a rotation axis RA. The axial direction according to the present embodiment indicates the direction in which the rotation axis RA of the shaft 13 extends. According to the present embodiment, in the electric motor 10, the side where the shaft 13 is connected to another member is referred to the front side. The side opposite to the front side is referred to the rear side. In the example illustrated in FIG. 2, an arrow 81 illustrates the front side of the electric motor 10.

The electric motor 10 includes a front-side housing 21 and a rear-side housing 22, as a housing. The rotor 11 is arranged inside the housing. The stator core 20 of the stator 12 is supported by the housings 21, 22. The housing 21 supports a bearing 14. A bearing support member 26, which supports a bearing 15, is fixed to the housing 22. The housings 21, 22 rotatably support the shaft 13 via the bearings 14, 15. A rear cover 23 is fixed to the rear-side end portion of the housing 22 for closing the space inside the housing 22. Thus, the components of the electric motor 10 can be exemplified to include the rotor 11, the rotor core 17, the magnet 18, the stator 12, the stator core 20, the coil 16, the housings 21, 22, the shaft 13, the rear cover 23, the bearing support member 26, the bearings 14, 15, a temperature detector 31, and a rotational position detector 32. The components of the electric motor 10 are not limited to this configuration, but any part constituting the electric motor 10 can be adopted. For example, a case for covering the stator may be adopted.

The rotational position detector 32 is arranged at the rear-side end portion of the shaft 13 in order to detect the rotational position or the rotation speed of the shaft 13. The rotational position detector 32 according to the present embodiment is composed of an encoder. The temperature detector 31, which detects the temperature of the coil 16, is fixed to the coil 16 of the stator 12. The temperature detector 31 according to the present embodiment is composed of a thermistor. The outputs of the temperature detector 31 and the rotational position detector 32 are input to the controller 41.

The controller 41 can determine that the electric motor 10 is overheated when the temperature detected by the temperature detector 31 is higher than a predetermined temperature judgment value. In this case, the controller 41 can lower the current value supplied to the electric motor 10 or stop the electric motor 10. Furthermore, the controller 41 can perform feedback control based on the output of the rotational position detector 32. For example, position feedback control for controlling the rotational position of the shaft 13 of the electric motor 10 or speed feedback control for controlling the rotation speed of the shaft 13 can be performed.

A temperature estimator 2 according to the present embodiment estimates the temperature output by the temperature detector 31 arranged in the coil 16 of the stator 12. In particular, according to the present embodiment, the temperature estimator 2 estimates the temperature of the temperature detector 31. Additionally, the temperature estimator 2 estimates the change in temperature of the temperature detector 31 over time.

The temperature estimator 2 is composed of an arithmetic processing device (computer) including a CPU as a processor. The temperature estimator 2 includes a storage part 51 that stores information about temperature estimation of the electric motor 10. The storage part 51 can be composed of non-transitory storage media that can store information, such as a volatile memory, a nonvolatile memory, or a hard disk. The temperature estimator 2 includes a display part 52 that displays information about the temperature of the electric motor 10. The display part 52 can be composed of any display panel such as a liquid crystal display panel.

The temperature estimator 2 includes an estimation unit 53 that estimates the temperature of the temperature detector 31. The estimation unit 53 estimates the temperature of the temperature detector 31 by performing a calculation according to the model for the electric motor (thermal model). The estimation unit 53 includes a loss calculating unit 54 that calculates the heat generation amount due to the primary copper loss of the coil 16 and the heat generation amount due to the iron loss of the stator core 20, based on an operation command for the electric motor The estimation unit 53 includes a temperature calculating unit 55 that calculates the temperature of the temperature detector 31 using the model for the electric motor. The temperature calculating unit 55 calculates the temperature of the temperature detector 31 based on the heat generation amount due to the primary copper loss and the iron loss, the heat capacity of the respective models for the components, and the heat transfer-related coefficients between the models for the components.

The temperature estimator 2 according to the present embodiment has a function of a parameter setting device for setting parameters included in the model for the electric motor. A parameter setting unit 61 of the temperature estimator 2 functions as a parameter setting device. The parameter setting unit 61 sets parameters including heat capacities in the components and heat transfer-related coefficients between the components, of the electric motor 10.

The parameter setting unit 61 includes a state acquiring unit 62 that acquires the state of the electric motor 10 in actually driving the electric motor 10. The state acquiring unit 62 acquires the operation command of the electric motor 10 generated by actually driving the electric motor the rotation speed output from the rotational position detector 32, and the temperature output from the temperature detector 31. The operation command for the electric motor 10 is generated in the operation control unit 43, so can be acquired from the operation control unit 43. Moreover, the state acquiring unit 62 can acquire the outside air temperature from an outside air temperature detector 33, which detects the temperature of the environment where the machine 1 is arranged.

The parameter setting unit 61 includes a parameter calculating unit 63 that calculates the parameters included in the model for the electric motor. The parameter calculating unit 63 calculates the heat generation amount of the coil 16 and the stator core 20 based on the operation command generated by the operation control unit 43 and the rotation speed detected by the rotational position detector 32. Furthermore, the parameter calculating unit 63 estimates the temperature of a model 31a for a temperature detector based on the heat generation amount of the coil 16 and the stator core 20. The parameter calculating unit 63 calculates the parameters of the model for the electric motor based on the temperature of the model 31a for the temperature detector and the temperature output from the temperature detector 31.

The parameter calculating unit 63 according to the present embodiment calculates parameters in a manner that the change in temperature of the model for the temperature detector calculated by the model for the electric motor corresponds to the change of actual temperature. The parameter calculating unit 63 can set the parameters of the model for the electric motor by machine learning. The parameter calculating unit 63 estimates the temperature of the temperature detector using the model for the electric motor by using the estimation unit 53. The parameter calculating unit 63 includes an evaluation unit 66 that evaluates the temperature of the model 31a for the temperature detector by comparing the temperature of model 31a for the temperature detector with the temperature of the temperature detector 31 acquired by the state acquiring unit 62. The parameter calculating unit 63 includes a parameter change unit 67 that changes the values of the parameters based on the evaluation results by the evaluation unit 66.

Each of the estimation unit 53, the loss calculating unit 54, and the temperature calculating unit 55 above corresponds to a processor driven according to a program. Each of the parameter setting unit 61, the state acquiring unit 62, and the parameter calculating unit 63 corresponds to a processor driven according to a program. In addition, each of the evaluation unit 66 and the parameter change unit 67 included in the parameter calculating unit 63 corresponds to a processor driven according to a program. Each processor performs the control prescribed by the program, thereby acting as a unit.

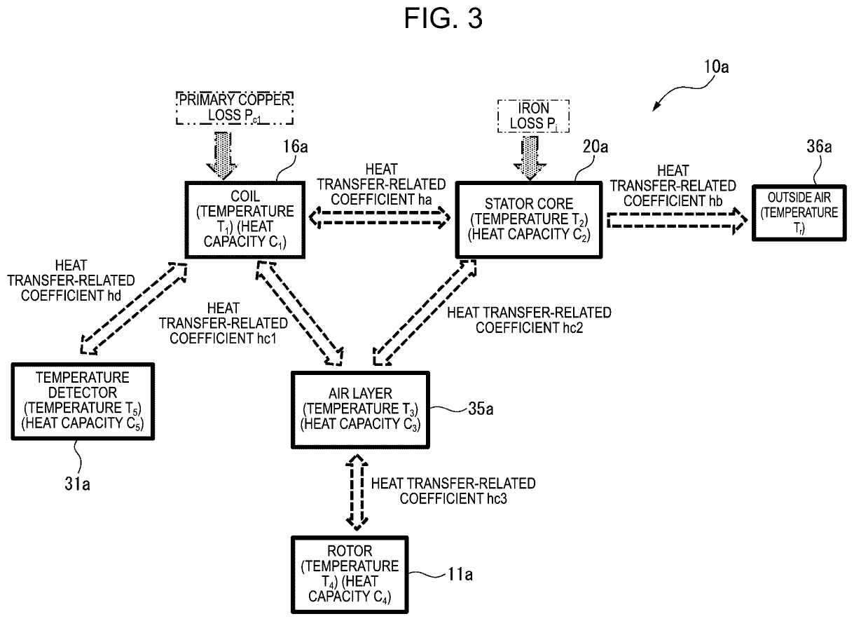

FIG. 3 illustrates a model for an electric motor that models the heat transfer of the first electric motor according to the present embodiment. A model 10a for the electric motor includes the models for the main components that constitute a first electric motor 10. The model 10a for the electric motor includes a model 11a for the rotor, a model 20a for the stator core, and a model 16a for the coil wound around the stator core. The model 10a for the electric motor also includes the model 31a for the temperature detector in order to detect the temperature of the coil 16.

Additionally, referring to FIG. 2, an air layer is interposed between the rotor 11 and the stator core 20. Furthermore, an air layer is interposed between the rotor 11 and the coil 16. The model 10a for the electric motor according to the present embodiment includes a model 35a for the air layer. The model 10a for the electric motor also includes a model 36a for the outside air as a model for the air around the electric motor 10. Thus, in the model for the electric motor according to the present embodiment, the models for the air layer and for the outside air are generated as the models of the components of the electric motor.

The temperature detected by the temperature detector 31 is almost equal to the temperature of the coil 16. However, the inventor has found that under certain conditions, the temperature detected by the temperature detector 31 may be different from the temperature of the coil 16 due to a small heat capacity of the temperature detector 31. More precisely, the temperature detected by the temperature detector 31 is the temperature of the body of the temperature detector 31. For this reason, in the present embodiment, for the temperature detector 31, the model 31a for the temperature detector is also generated as one of the component models. Note that without considering the heat capacity of the temperature detector 31, it may be calculated by assuming that the temperature of the model 31a for the temperature detector is the same as the temperature of the model for the component to which the temperature detector 31 is attached. In the example here, the temperature of the model 31a for the temperature detector may be calculated as identical to the temperature of the model 16a for the coil.

In the model 10a for the electric motor, multiple parameters, including heat capacity and heat transfer-related coefficient, are set. In each model for the component, heat capacity is set. In the model 16a for the coil, the model 20a for the stator core, the model 35a for the air layer, the model 11a for the rotor and the model 31a for the temperature detector, temperatures T₁, T₂, T₃, T₄, T₅ as variables and heat capacities C₁, C₂, C₃, C₄, C₅ as constants are set, respectively. Furthermore, in the model 36a for the outside air, a temperature Tᵣ is set as a variable.

Heat from one component of the electric motor 10 is transferred to the other components. In the model 10a for the electric motor, the heat transfer between the components is calculated. Heat transfer-related coefficients are set between the models for respective components of the electric motor 10. In the example here, a coefficient is defined by multiplying the heat transfer coefficient by a contact area.

A heat transfer-related coefficient ha is set between the model 20a for the stator core and the model 16a for the coil. A heat transfer-related coefficient hc1 is set between the model 35a for the air layer and the model 16a for the coil. A heat transfer-related coefficient hc2 is set between the model 35a for the air layer and the model 20a for the stator core. A heat transfer-related coefficient hc3 is set between the model 35a for the air layer and the model 11a for the rotor. A heat transfer-related coefficient hd is set between the model 16a for the coil and the model 31a for the temperature detector. Furthermore, in order to simulate the release of heat from the stator core 20 to the outside air, a heat transfer-related coefficient hb is set between the model 20a for the stator core and the model 36a for the outside air.

In the model 10a for the electric motor according to the present embodiment, a primary copper loss P_{c1} generated in the coil 16 of the stator 12 is considered as heat generated by the component. Heat generation amount due to the primary copper loss is input to the model 16a for the coil. Also, an iron loss Pᵢ of the stator core 20 is considered, which is generated due to the magnetic force of the magnet 18 in the rotor 11. Heat generation amount due to the iron loss is input to the model 20a for the stator core.

Heat moves between respective components such as the coil and the stator core, depending on the magnitude of the heat transfer-related coefficient. Each component also has its temperature rise and fall based on the difference between incoming heat amount and outgoing heat amount. The temperature change rate of each component of the model 10a for the electric motor illustrated in FIG. 3 can be expressed by the following Equations (1) to (5). In each component, the temperature change rate can be calculated by dividing the difference between the heat input amount and heat output amount by the heat capacity.

$$\begin{matrix}Math . 1 & \\ \frac{{dT}_{1}}{dt} = \frac{{P}_{c 1} + ha ( {T}_{2} - {T}_{1} ) + hc 1 ( {T}_{3} - {T}_{1} )}{{C}_{1}} & ( 1 )\end{matrix}$$

$$\frac{{dT}_{2}}{dt} = \frac{{P}_{i} + ha ( {T}_{1} - {T}_{2} ) + hb ( {T}_{r} - {T}_{2} ) + hc 2 ( {T}_{3} - {T}_{2} )}{{C}_{2}} \qquad ( 2 )$$

$$\frac{{dT}_{3}}{dt} = \frac{hc 1 ( {T}_{1} - {T}_{3} ) + hc 2 ( {T}_{2} - {T}_{3} ) + hc 3 ( {T}_{4} - {T}_{3} )}{{C}_{3}} \qquad ( 3 )$$

$$\frac{{dT}_{4}}{dt} = \frac{hc 3 ( {T}_{3} - {T}_{4} )}{{C}_{4}} \qquad ( 4 )$$

$$\frac{{dT}_{5}}{dt} = \frac{hd ( {T}_{1} - {T}_{5} )}{{C}_{5}} \qquad ( 5 )$$

$${T}_{1} : Temperature of Coil , {C}_{1} : Heat capacity of coil$$

$${T}_{2} : Temperature of stator core , {C}_{2} : Heat capacity of stator core$$

$${T}_{3} : Temperature of air layer , {C}_{3} : Heat capacity of air layer$$

$${T}_{4} : Temperature of rotor , {C}_{4} : Heat capacity of rotor$$

$$\begin{matrix}{T}_{5} : Temperature of temperature detector , \\ {C}_{5} : Heat capacity of temperature detector\end{matrix}$$

$$ha , hb , hc 1 , hc 2 , hc 3 , hd : Heat transfer - related coefficient$$

$${P}_{c 1} : Primary copper loss$$

$${P}_{i} : Iron loss$$

The heat capacities C₁, C₂, C₃, C₄, C₅ of the respective components are constant and can be predetermined. Each of the heat transfer-related coefficients ha, hb, hc1, hc2, hc3 and hd is the coefficient acquired by multiplying the heat transfer coefficient by the contact area. The coefficients ha, hb, hc1, hc2, hc3 and hd are constant and can be predetermined. The loss calculating unit 54 of the estimation unit 53 calculates the primary copper loss P_{c1} in the coil 16 and the iron loss Pᵢ in the stator core as described below. The temperature calculating unit 55 of the estimation unit 53 can calculate the change amount in temperature for a minute time period dt based on Equations (1) to (5) above.

Next, the calculation method of the primary copper loss P_{c1} and the iron loss Pᵢ included in Equations (1) and (2) will be described. The rotation speed of the electric motor 10 and the load factor of the electric motor 10 (percentage of the maximum load) can be preset by the operator according to the work performed by the machine. The loss calculating unit 54 of the estimation unit 53 calculates the primary copper loss P_{c1} and the iron loss Pᵢ. Table 1 illustrates a loss map for calculating loss.

TABLE 1
Table 1 Loss Map

| Rotational | Loss Pm at | | Current Im at |
|---|---|---|---|
| Speed | Maximum | Loss Pn at No | Maximum |
| N [rpm] | Power [kW] | Load [kW] | Power [A] |
| 0 | 3.12 | 0.001 | 166.8 |
| 1000 | 4.01 | 0.0239 | 166.8 |
| 2000 | 2.57 | 0.064 | 166.4 |
| 3000 | 2.7 | 0.065 | 165.7 |
| 4000 | 2.73 | 0.086 | 165.3 |
| 5000 | 2.72 | 0.179 | 165.4 |
| 6000 | 4.49 | 0.2 | 165.4 |
| 7000 | 4.03 | 0.227 | 158 |
| 8000 | 3.066 | 0.27 | 150.3 |
| 9000 | 4.38 | 0.256 | 145.8 |
| 10000 | 3.55 | 0.282 | 142 |
| 11000 | 5.68 | 0.291 | 137 |
| 12000 | 3.5 | 0.348 | 135 |

Table 1 illustrates the loss at maximum power to the rotation speed (the number of revolutions) of the electric motor 10, the loss at no load, and the current at maximum power. A loss Pₘ at maximum power is the loss when the load factor of the electric motor is 100%, which is determined by the rotation speed of the electric motor. A loss Pₙ at no load is the loss when the load factor of the electric motor is zero, which depends on the rotation speed of the electric motor. A current Iₘ at maximum power is the current value when the load factor is 100% at each rotation speed. The loss map illustrated in Table 1 can be created by actually driving an electric motor. This loss map can be stored in the storage part 51 of the temperature estimator 2, for example.

The loss calculating unit 54 calculates a total loss Pₜ including the primary copper loss P_{c1} and the iron loss Pᵢ. The total loss Pₜ can be calculated by the following Equations (6) and (7).

Math. 2

Pₜ=k2·LF²+k1·LF+Pₙ (6)

k1=Pₘ−Pₙ−k2 (7)
Pₜ: Total loss
Pₘ: Loss at maximum power
Pₙ: Loss at no load
LF: Load factor of electric motor
k1, k2: Constant

The total loss Pₜ can be calculated by the loss Pₘ at maximum power, the loss Pₙ at no load, and a load factor LF of the electric motor. Since the rotation speed and the load factor of the electric motor are specified, the loss Pₘ at maximum power and the loss Pₙ at no load can be found from Table 1. Constants k1, k2 can be defined in advance by the operator. The primary copper loss P_{c1} can then be calculated by the following Equations (8) and (9).

Math. 3

P_{c1}=r1·I² (8)

I=Iₘ·LF (9)
P_{c1}: Primary copper loss
I: Current
r1: Primary resistance
Iₘ: Current at maximum power

The primary copper loss P_{c1} corresponds to the current Joule heat flowing through the coil 16. In addition, a current I flowing through the coil 16 can be calculated by multiplying the current Iₘ at maximum power by the load factor LF of the electric motor. The current Iₘ at maximum power can be acquired from Table 1. Here, a primary resistance r1 of the coil 16 is measured in advance. Then, the iron loss Pᵢ can be calculated by the following Equation (10). The iron loss Pᵢ can be calculated by subtracting the primary copper loss P_{c1} from the total loss Pₜ.

Math. 4

Pᵢ=Pₜ−P_{c1} (10)
Pᵢ: Iron loss

The operator inputs the operating pattern of the electric motor, including the rotation speed and the load factor for driving the machine 1. The temperature calculating unit 55 of the estimation unit 53 may initially set the temperatures T₁ to T₅ of respective components to any temperatures. For example, the temperature calculating unit 55 sets the temperatures T₁ to T₅ of the components to the normal outside air temperature Tᵣ. The temperature Tᵣ of the outside air can be predetermined depending on where the machine 1 is placed.

The loss calculating unit 54 of the estimation unit 53 calculates the primary copper loss and the iron loss based on the rotation speed and the load factor of the electric motor in the operating pattern. Next, the temperature calculating unit 55 can calculate the change amount of a temperature T₅ of the temperature detector 31 for the minute time period dt by solving Equations (1) to (5) above. Thus, the operator can determine the operating pattern of the electric motor and estimate the change in the temperature of the temperature detector over time when the electric motor is operated in the operating pattern. The operator can adjust the operating pattern of the electric motor including the rotation speed and the load factor of the electric motor according to the change in temperature of the temperature detector 31. That is, the operator can adjust the operating pattern of the machine containing the electric motor.

In the model 10a for the electric motor according to the present embodiment, it is sufficient that the temperature of one of the multiple components in the electric motor can be accurately estimated. The temperatures of the components other than the one component may be away from the actual temperatures of themselves. That is, the temperatures of the components other than the one component may be different from the actual temperatures of themselves and may not correspond to the actual temperatures. In the example here, it is sufficient that the temperature T₅ of the model 31a for the temperature detector can be accurately estimated, and the temperature T₁ of the model 16a for the coil, a temperature T₂ of the model 20a for the stator core, a temperature T₃ of the model 35a for the air layer, and a temperature T₄ of the model 11a for the rotor may be far from the actual temperature of themselves.

Furthermore, the heat capacities C₁ to C₅ set in the model 10a for the electric motor and the heat transfer-related coefficients ha, hb, hc1 to hc3 and hd set between the components have unique values depending on the material, shape and arrangement, or the like, of each component. However, in the model 10a for the electric motor according to the present embodiment, at least some of the parameters of the multiple heat capacities and the multiple heat transfer-related coefficients are set to values away from the actual heat capacities or the actual heat transfer-related coefficients. In other words, at least some parameters are set to values different from the actual heat capacities or the actual heat transfer-related coefficients.

Each parameter is set in a manner that the change in temperature T₅ of the model 31a for the temperature detector corresponds to the actual change of temperature. In the model 10a for the electric motor according to the present embodiment, the change in temperature of the temperature detector 31 corresponds to the actual change in temperature by calculating the heat transfer between the models for respective components. For example, even when the temperatures of the coil, the stator core, and the like are further from the actual temperatures respectively, the parameters of the model for the electric motor are set in a manner that the temperature of the temperature detector indicates a value close to the actual temperature. As a result of setting the heat capacities and the heat transfer-related coefficients by the parameter setting device described later, all the heat capacities and the heat transfer-related coefficients of the components may have the same value as the actual heat capacities and the heat transfer-related coefficients. And when the estimation unit estimates the temperatures of the components, the temperatures of all the components may be the same as the actual temperatures of themselves.

Thus, the model for the electric motor according to the present embodiment is generated in order to estimate the temperature output by the temperature detector attached to the stator coil as a component of one electric motor. Next, a parameter setting device for setting parameters including heat transfer-related coefficients and heat capacities, is described.

Referring to FIG. 1, the parameter setting unit 61 according to the present embodiment sets the heat capacities and the heat transfer-related coefficients contained in the model 10a for the electric motor, and constants k1, k2 in Equations (6) and (7). The operator actually drives the electric motor 10 according to a predetermined operating pattern. The state acquiring unit 62 acquires the load factor of the electric motor 10, the rotation speed of the electric motor 10, and the temperature output from the temperature detector 31, as a state of the electric motor 10. In addition, the state acquiring unit 62 acquires the outside air temperature from the outside air temperature detector 33.

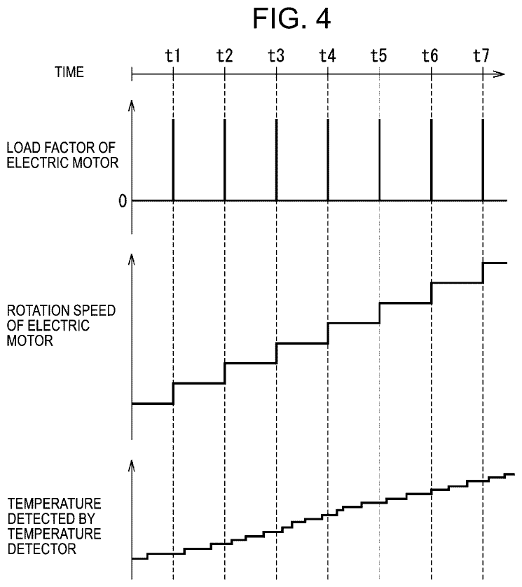

FIG. 4 illustrates a graph of a first operating pattern when the electric motor is driven in order to set the parameters included in the model for the electric motor according to the present embodiment. FIG. 4 illustrates the operating pattern at no load. In this operating pattern, the rotation speed of the electric motor 10 is gradually increased without loading the electric motor 10. The rotation speed of the electric motor 10 is increased by temporarily increasing the load factor of the electric motor at predetermined time intervals.

Temperature detected by the temperature detector 31 is gradually increasing. At times t1 to t7, by temporarily increasing the load factor of the electric motor 10, the rotation speed of the electric motor 10 is increased. The state acquiring unit 62 acquires the operating state of the electric motor 10 and the temperature output from the temperature detector 31 during the period when the rotation speed of the electric motor 10 is gradually increased. More specifically, the state acquiring unit 62 acquires the load factor of the electric motor 10, the rotation speed of the electric motor 10, and the temperature output from the temperature detector 31 for each predetermined minute time period, which are stored in the storage part 51. In the present embodiment, a constant outside air temperature is adopted, but the embodiments are not limited to this configuration. The state acquiring unit 62 may detect the outside air temperature for each minute time period from the outside air temperature detector 33.

Referring to FIG. 1, the state acquiring unit 62 acquires a torque command included in the operation command generated by the operation control unit 43 of the controller 41. The state acquiring unit 62 can calculate the load factor of the electric motor 10 from the torque command. For example, the operation control unit 43 includes a position controller, and a speed controller. The position controller calculates a speed command from the position command based on the operation program. The speed controller calculates a torque command based on the speed command. The current supplied to the electric motor 10 is determined based on the torque command. The operation control unit 43 supplies electricity to the electric motor 10 by sending the torque command or a current command to the drive device 44. The torque command corresponds to the load factor of the electric motor 10, so that the state acquiring unit 62 can calculate the load factor from the torque command.

The parameter calculating unit 63 calculates the parameters of the model 10a for the electric motor based on the variables acquired by the state acquiring unit 62. The parameter calculating unit 63 according to the present embodiment calculates parameters including the heat capacities C₁, C₂, C₃, C₄, C₅ and the heat transfer-related coefficients ha, hb, hc1, hc2, hc3, and hd based on the heat generation amount in the coil 16 and the stator core 20 and the temperature detected by the temperature detector 31. In addition, the parameter calculating unit 63 calculates the constants k1, k2 in Equations (6) and (7), as parameters. The parameter calculating unit 63 calculates the parameters in a manner that the change in the temperature of the model 31a for the temperature detector during the simulation is close to the change in the actual temperature.

The parameter calculating unit 63 sets an initial value of each parameter. The initial values of the parameters can be set in any way. The parameter calculating unit 63 includes a loss calculating unit that calculates the heat generation amount due to the primary copper loss of the coil 16 and the heat generation amount due to the iron loss of the stator core 20. The function of the loss calculating unit of the parameter calculating unit 63 is the same as the function of the loss calculating unit 54 of the estimation unit 53. Thus, the parameter calculating unit 63 uses the loss calculating unit 54 of the estimation unit 53 in order to calculate heat generation amount. The loss calculating unit 54 calculates the primary copper loss P_{c1} and the iron loss Pᵢ by using Table 1 and Equations (6) to (10) based on the rotation speed of the electric motor 10 and the load factor of the electric motor 10 acquired by the state acquiring unit 62. Equations (6) and (7) for calculating the primary copper loss P_{c1} and the iron loss Pᵢ include the constants k1, k2. Furthermore, the loss calculating unit 54 calculates loss for the predetermined minute time period dt, i.e., heat generation amount for a minute time period. Thus, the loss calculating unit 54 calculates the primary copper loss P_{c1} and the iron loss Pᵢ in Equations (1) and (2) based on the actually measured values including the operation command for the electric motor (load factor) and the output of the rotational position detector 32.

The parameter calculating unit 63 includes a temperature calculating unit that estimates the temperature of the temperature detector by using the model for the electric motor. The function of the temperature calculating unit of the parameter calculating unit 63 is the same as the function of the temperature calculating unit 55 of the estimation unit 53. Thus, the parameter calculating unit 63 uses the temperature calculating unit 55 of the estimation unit 53 in order to estimate the temperatures of the components. The temperature calculating unit 55 estimates the temperature of the temperature detector 31 based on the model 10a for the electric motor by using the respective parameters and the loss calculated by the loss calculating unit 54. That is, the temperature of the model 31a for the temperature detector is estimated by simulation.

The temperature calculating unit 55 can estimate the change in temperature as detected by the temperature detector 31 over time after starting to drive the electric motor 10 based on the tentatively set parameters. The temperature of the model for each component of the electric motor 10 can be calculated by using the differential equations from Equations (1) to (5) above. The initial value of the temperature of each component model can be set to, for example, the temperature of the outside air when the electric motor 10 starts driving, i.e., the room temperature.

The evaluation unit 66 of the parameter calculating unit 63 evaluates the temperature of the model 31a for the temperature detector by comparing the temperature of the model 31a for the temperature detector calculated in the temperature calculating unit 55 with the temperature actually measured by the temperature detector 31. The evaluation unit 66 evaluates the parameters tentatively set in the model 10a for the electric motor. The evaluation unit 66 according to the present embodiment evaluates only the temperature of the model 31a for the temperature detector without evaluating variables other than the temperature of the model 31a for the temperature detector. For example, in addition to the temperature detector 31, additional temperature detectors can be attached to components other than the coil 16, thereby detecting the actual temperature. It is possible to compare the temperatures of multiple temperature detectors with the temperatures by simulation. However, in the example here, it is sufficient that the change in temperature of the model 31a for the temperature detector is close to the actual change in temperature and at least some of the temperatures of other components are not evaluated.

Next, the parameter change unit 67 of the parameter calculating unit 63 changes the parameters based on the results of the evaluation in the evaluation unit 66. Then, based on the changed parameters, calculation of loss by the loss calculating unit 54, calculation of the temperature of the model for the temperature detector by the temperature calculating unit 55, evaluation by the evaluation unit 66, and change of parameters by the parameter change unit 67 are repeated by the same calculation as above. The evaluation by the evaluation unit, when satisfying predetermined conditions, can be determined as the final parameters.

Here, the number of combinations of multiple parameters in the model 10a for the electric motor is very large. Multiple parameters can be defined by a method of machine learning. For example, multiple parameters can be set by a method of Bayesian optimization.

In Bayesian optimization, an objective function to be evaluated is generated for explanatory variables including parameters as inputs. Then the parameters are searched and set for which the objective function is expected to be minimum or maximum. By repeating this search for the parameters, the optimal value of the parameters can be set. In addition, the range in which each parameter is set can be predetermined.

Here, with respect to the temperature of the temperature detector 31, the difference between the temperature of the model 31a for the temperature detector model estimated by the model 10a for the electric motor and the temperature detected by the actual temperature detector 31 is set as the objective function. That is, with respect to the temperature of the temperature detector 31, the objective function can use a difference between the predicted value calculated from Equations (1) to (5) based on the tentatively set parameters and the actually measured value actually detected by the temperature detector 31. As the objective function, for example, the average value of the differences within minute time periods, or the like can be adopted. Then the next parameter is searched in a manner that the objective function becomes small.

The Bayesian optimization can repeat searches of the parameters and evaluations of the parameters. The evaluation unit 66 can adopt the values of the current parameters as long as the objective function is within a predetermined determination range. On the other hand, when the objective function deviates from the predetermined determination range, the next search of parameters can be performed. In the Bayesian optimization method, the amount of computation is reduced because the search is performed while predicting the region where the solution exists.

Alternatively, in addition to setting parameters by Bayesian optimization, the range in which each parameter is set can be predetermined. The parameter change unit 67 of the parameter calculating unit 63 sets multiple parameters at random within a range of parameters. The temperature calculating unit 55 estimates the temperature of the model 31a for the temperature detector based on the set parameters. The evaluation unit 66 can evaluate the set parameters based on the actually measured values of the temperatures acquired from the temperature detector 31. Such a method of setting parameters is referred to as a random search method.

Alternatively, the parameter change unit 67 can set parameters at predetermined intervals within the range in which the parameters are set. The temperature calculating unit 55 estimates the temperature of the model 31a for the temperature detector by using the set parameters. The evaluation unit 66 evaluates all combinations of discretely set parameters. This method is referred to as a grid search method.

In the random search method or the grid search method, as in the Bayesian optimization method, the evaluation unit 66 allows the temperature of the temperature detector 31 to be evaluated. The evaluation unit 66 can adopt the values of the current parameters as long as the objective function is within a predetermined determination range. Alternatively, the evaluation unit 66 can adopt the parameters for which the objective function is best. The evaluation unit 66 can determine the parameters in the model 10a for the electric motor that closely match the temperature detected by the actual temperature detector 31.

In the present embodiment, control of repeating the setting of the temporary parameters, the estimation of the temperature of the temperature detector by the model for the electric motor, and the evaluation of the temporary parameters, is performed. The parameter is set in a manner that the change in temperature detected by the temperature detector 31 can be accurately estimated. In the present embodiment, only the temperature of the temperature detector that detects the temperature of the coil can be evaluated in the parameter evaluation because the temperatures other than the temperature detector may be away from the actual temperatures. Thus, parameters can be set in a short time period with less computational effort.

In FIG. 4, the operation at no load is illustrated as the operating pattern that actually drives the electric motor 10, but the operation pattern is not limited to this configuration. When determining the parameters of the model 10a for the electric motor, it is preferable to acquire the operating state of the electric motor 10 by driving the electric motor 10 in various operating state.

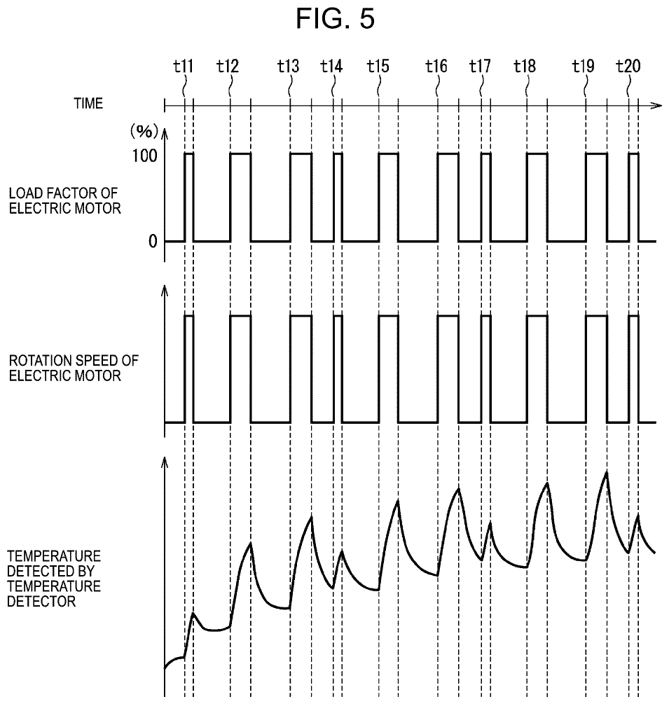

FIG. 5 illustrates a second operating pattern that actually drives the electric motor in order to set the parameters of the model for the electric motor. In the second operating pattern, the load factor of the electric motor 10 repeatedly rises and falls. The load factor of the electric motor 10 is greatly changed, thereby changing the rotation speed of the electric motor. Temperature detected by the temperature detector 31 rises or falls rapidly. That is, the second operating pattern involves a steep temperature change of the electric motor.

In the example illustrated in FIG. 5, the load factor of the electric motor 10 is increased from 0% to 100% at each time from time t11 to time t20. The rotation speed of the electric motor increases and the temperature detected by the temperature detector 31 increases. After a predetermined period of time has elapsed, the load factor of the electric motor 10 is reduced to 0%. The rotation speed of the electric motor 10 decreases and the temperature detected by the temperature detector 31 decreases. The state acquiring unit 62 can acquire the operation command, the rotation speed, and the temperature output from the temperature detector 31 during the operation in which the load factor of the electric motor 10 repeatedly rises and falls.

In the first operating pattern at no load as illustrated in FIG. 4, or in the second operating pattern with a sudden change in temperature as illustrated in FIG. 5, the temperature estimated by the estimation unit 53 is prone to error. By driving the electric motor in the first operating pattern or the second operating pattern and setting the parameters of the model for the electric motor, the parameters can be adjusted according to various load conditions. As a result, it is possible to calculate parameters that accurately estimate the temperature of the temperature detector in various operating patterns.

In the above embodiment, as one component of the electric motor for estimating temperature, the coil including windings is adopted as an example, but embodiments are not limited to this configuration. Any component of the electric motor can be adopted as a component for estimating the temperature. Referring to FIG. 3, for example, the stator core, the rotor, or the air layer may be selected as a component whose temperature is estimated. In this case, the temperature detector is arranged so as to detect the actual temperature of the component whose temperature is estimated by the temperature estimator. For example, when the temperature estimator estimates the temperature of the stator core, a temperature detector can be attached to the stator core so as to detect the temperature of the stator core.

In the temperature estimator according to the present embodiment, it is sufficient that the temperature of one component can be accurately estimated. Thus, at least some of the parameters for the multiple heat capacities and the multiple heat transfer-related coefficients may be set to values different from the actual heat capacities and the actual heat transfer-related coefficients, respectively. The operator selects one component of the electric motor and attaches the temperature detector to this component. The parameter setting device can set parameters such as heat transfer-related coefficient in the same manner as the setting of parameters for detecting the temperature of the coil described above. The evaluation unit of the parameter calculating unit evaluates the temperature of the model for the temperature detector by comparing the temperature of the model for the temperature detector with the temperature acquired by the actual temperature detector. The parameter change unit can then change parameters based on the results of the evaluation unit. In addition, the evaluation unit can determine the parameters as the final parameters when the parameters satisfy a predetermined condition.

In the above embodiment, a synchronous motor in which the rotor has a permanent magnet is described, but embodiments are not limited to this configuration. The model for the electric motor according to the present embodiment can also be applied to an induction motor in which the rotor does not include a permanent magnet.

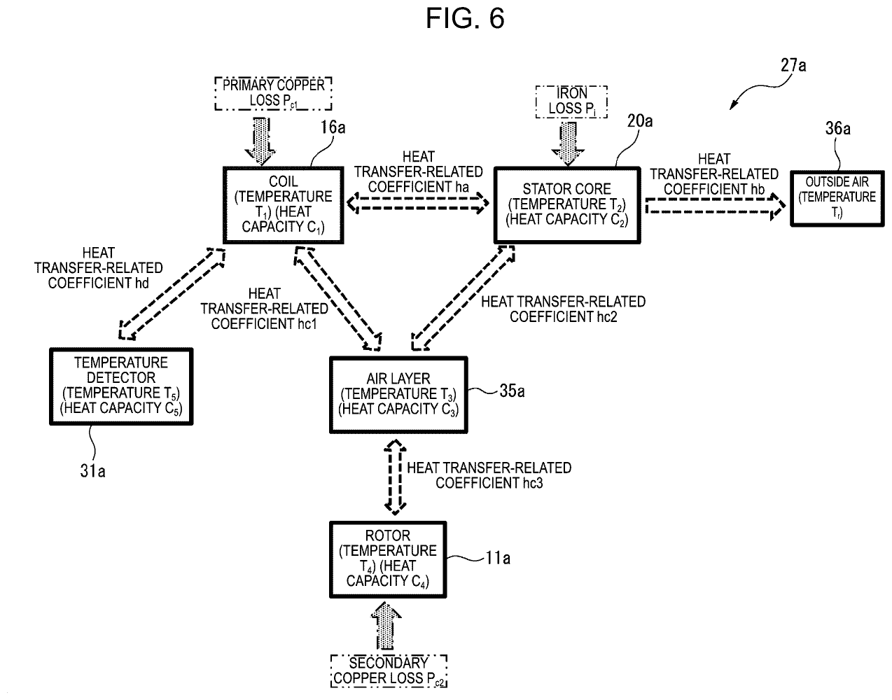

FIG. 6 illustrates a model for a second electric motor according to the present embodiment. The second electric motor is an induction motor. The rotor of an induction motor includes a basket-shaped conductor formed of stainless steel or copper or the like. The rotor of the induction motor does not include a permanent magnet. The basket-shaped conductor is fixed to the shaft and rotates integrally with the shaft. In an induction motor, the magnetic force generated by the coil of the stator causes an induced current to flow inside the basket-shaped conductor. A magnetic field is generated around the basket-shaped conductor and the rotor rotates.

In an induction motor, a secondary copper loss P_{c2} occurs as a secondary loss because the current flows through the basket-shaped conductor. The secondary loss corresponds to the Joule heat due to the current flowing through the basket-shaped conductor. In a model 27a for the second electric motor, heat is generated in the rotor due to the secondary copper loss. In the second electric motor, the heat capacities of the components and the heat transfer-related coefficients between the components are the same as in the model 10a for the first electric motor.

Among the differential equations for the temperatures of the respective components in the model 27a for the second electric motor, the differential equation for calculating the temperature of the rotor is different from that in the model 10a for the first electric motor. The differential equation for expressing the change in temperature of the rotor is represented by the Equation (11) below:

$$\begin{matrix}Math . 5 & \\ \frac{{dT}_{4}}{dt} = \frac{{P}_{c 2} + hc 3 ( {T}_{3} - {T}_{4} )}{{C}_{4}} & ( 11 )\end{matrix}$$

$${P}_{c 2} : Secondary copper loss$$

In Equation (11), the heat generation amount of the secondary copper loss P_{c2} is added to Equation (4) of the model 11a for the rotor of the first electric motor. The differential equations representing temperature changes in the other components, which are the coil, the stator core, the air layer, and the temperature detector, are identical to the differential equations in a thermal model for the first electric motor.

Here, a calculation method for the heat generation amount due to the secondary copper loss is described. In order to calculate the secondary copper loss in the conductor of a rotor, it is required to estimate the current flowing through the conductor.

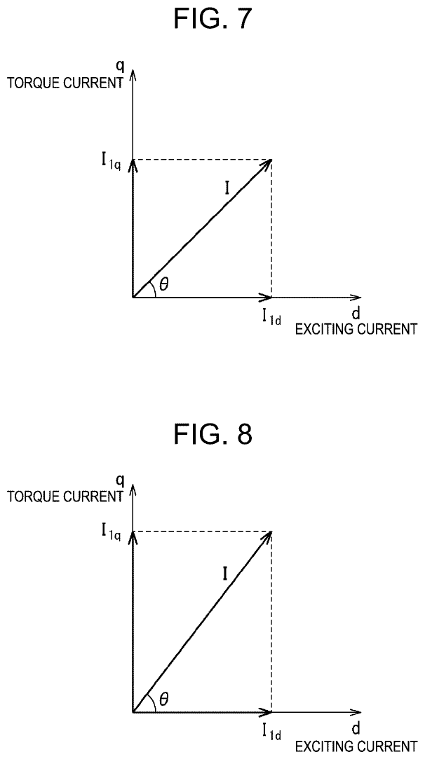

FIG. 7 illustrates a graph of a current of a d-axis and a current of a q-axis when performing vector control of an induction motor. In FIG. 7, the current of the d-axis and the current of the q-axis flowing through the stator are indicated by arrows. The d-axis indicates current for exciting the coil, and the q-axis indicates current for generating the torque of the electric motor. The overall current I flowing into the stator core is calculated by adding a current I_{1d} of the d-axis and a current I_{1d} of the q-axis in vector. Here, when the exciting current is small, an angle θ between the current I and the current I_{1d} of the d-axis is 45°.

FIG. 8 illustrates a graph of the current of the d-axis and the current of the q-axis as the exciting current increases. FIG. 8 is a graph when the exciting current exceeds the maximum current. As the exciting current increases, the angle θ of the current I to the current I_{1d} of the d-axis becomes larger than 45°. In the present embodiment, the equation for calculating the current of the q-axis of the primary-side coil is changed according to the magnitude of the d-axis current. As illustrated in Equations (12) and (13), based on a predetermined exciting current Iₑ, the current I_{1q} of the q-axis is calculated.

$$\begin{matrix}Math . 6 & \\ In the case of {I}_{1 q} < \sqrt{2} \cdot {I}_{e} & ( 12 )\end{matrix}$$

$${I}_{1 q} = I$$

$$In the case of {I}_{1 q} ≧ \sqrt{2} \cdot {I}_{e} \qquad ( 13 )$$

$${I}_{1 q} = \sqrt{{I}^{2} = {I}_{e}^{2}}$$

$${I}_{1 q} : Current of q - axis on primary side$$

$${I}_{e} : Exciting current$$

$$I : Current$$

Here, the current I is calculated by multiplying the current Iₘ at maximum power by the load factor of the electric motor. The secondary copper loss P_{c2} can then be calculated by the following Equation (14) based on the current I_{1q} of the q-axis of the primary-side coil.

$$\begin{matrix}Math . 7 & \\ {P}_{c 2} = \frac{r 2 \cdot {M}^{2} \cdot {I}_{1 q}^{2}}{L {2}^{2}} & ( 14 )\end{matrix}$$

$${P}_{c 2} : Secondary copper loss$$

$$R 2 : Secondary resistance$$

$$M : Mutual inductance$$

$$L 2 : Secondary Inductance$$

Here, an inductance L2 is the inductance of the basket-shaped conductor, and a mutual inductance M is a mutual inductance between the basket-shaped conductor and the stator coil. These, i.e., the inductance L2, the mutual inductance M and a secondary resistance r2 of the conductor can be predetermined. The total loss Pₜ and primary copper loss P_{c1} in an induction motor can be calculated similarly to total loss and primary copper loss in a synchronous motor. Then, iron loss Pᵢ can be calculated by the following Equation (15):

Math. 8

Pᵢ=Pₜ−P_{c1}−P_{c2} (15)
Pᵢ: Iron loss

Thus, the primary copper loss, the iron loss, and the secondary copper loss can also be calculated in the second electric motor. By using the model 27a for the second electric motor, the temperature of the temperature detector for detecting the temperature of the component such as the stator coil can be estimated. Furthermore, the parameter setting unit 61 can set the values of parameters such as heat capacities included in the model for the second electric motor in the same way as the setting of the values of parameters included in the model for the first electric motor.

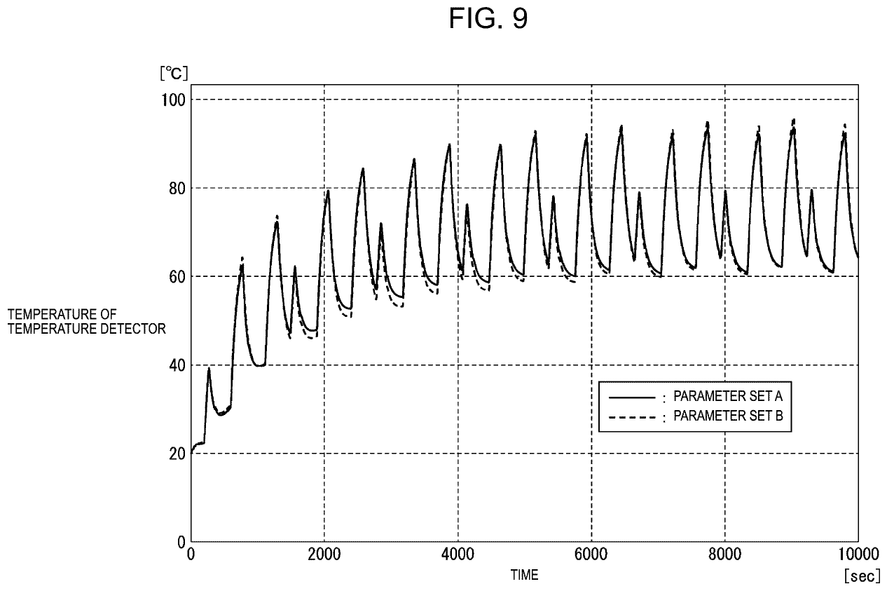

FIG. 9 illustrates a graph of the temperature of the temperature detector estimated by the estimation unit by using the parameters set in the parameter setting unit according to the present embodiment. FIG. 9 illustrates a graph of the simulation performed with a parameter set A and a parameter set B whose values differ from each other. Here is an example of a second electric motor. The parameter set A and the parameter set B are set in the parameter setting unit 61. The parameters included in the parameter set A and the parameter set B are illustrated in Table 2.

TABLE 2
Table 2 Parameters
Unit of Heat Transfer-Related Coefficient: [W/K]
Unit of Mass: [kg]

| | Parameter | Parameter |
|---|---|---|
| | Set A | Set B |
| Heat Transfer-Related Coefficient ha | 5.48 | 6.72 |
| Heat Transfer-Related Coefficient hb | 10.82 | 13.78 |
| Heat Transfer-Related Coefficient hc1 | 2.82 | 1.49 |
| Heat Transfer-Related Coefficient hc2 | 1.056 | 13.35 |
| Heat Transfer-Related Coefficient hc3 | 7.5 | 7.26 |
| Heat Transfer-Related Coefficient hd | 14.7 | 4.88 |
| Mass m₁ of Coil | 1.37 | 1.37 |
| Mass m₂ of Stator Core | 23.19 | 24.2 |
| Mass m₃ of Air Layer | 0.00347 | 0.000353 |
| Mass m₄ of Rotor | 3.43 | 4.7 |
| Mass m₅ of Temperature Detector | 0.072 | 0.02 |

The parameter set A and the parameter set B are acquired by driving the second electric motor with different operating patterns. Table 2 describes the heat transfer-related coefficients that are acquired by multiplying the heat transfer coefficients between respective components of the electric motor by the respective contact areas. Heat capacity is also calculated by multiplying the specific heat of the material in each component by the mass. The specific heat of each material can be predetermined, so that Table 2 illustrates mass m of each component for calculating heat capacity. Comparing the parameter set A with the parameter set B, we can see that some parameters such as heat transfer-related coefficients hc2, hd and rotor mass m₄ have very different values between the two parameter sets A and B.

On the other hand, referring to FIG. 9, it can be seen that the temperature of the temperature detector estimated by using the parameter set B is in good agreement with the temperature of the temperature detector estimated by using the parameter set A. In particular, there is a good agreement between temperature changes both during periods when temperature rises and when temperature fluctuates within a predetermined range. Furthermore, the temperature change illustrated in FIG. 9 estimated by the estimation unit 53 agrees well with the temperature change detected by the temperature detector 31 when the electric motor 10 is actually driven.

There are some parameters with very different values between the parameter set A and the parameter set B. Thus, it can be seen that at least one of the parameter set A and the parameter set B has different values from the parameter set in the actual electric motor. In particular, it can be seen that at least some of the parameters among the multiple heat capacities and the multiple heat transfer-related coefficients are set to values different from the actual heat capacities or the actual heat transfer-related coefficients. For example, of the coefficient hc2 of the parameter set A and the coefficient hc2 of the parameter set B, it can be seen that the coefficient for at least one of the heat transfer-related coefficients is far from the actual heat transfer-related coefficient.

Thus, in the temperature estimator according to the present embodiment, the temperature of the temperature detector can be accurately estimated even when at least some of the parameters among the multiple parameters are different from the actual values. Also, the parameter setting device according to the present embodiment can set the parameters of the model for such an electric motor. As described above, when the parameter setting device calculates the heat capacities and the heat transfer-related coefficients, all the heat capacities and all the heat transfer-related coefficients may have the same value as the actual heat capacities and the actual heat transfer-related coefficients. Then, when the temperatures of the components are estimated by the estimation unit, the temperatures of all the components may correspond to the actual temperatures of the components with good accuracy.

The model for the electric motor according to the above embodiment is composed of the model for the coil, the model for the stator core, the model for the temperature detector, the model for the air layer, the model for the rotor, and the model for the outside air, but the models are not limited to this configuration. The model for the electric motor may include models for other components. For example, the model for the electric motor may include a model for a housing for supporting the stator and the rotor, a model for a bearing, a model for a shaft for supporting the rotor. Or, the model for the electric motor may not include some models for the components. For example, the model for the electric motor may not include the model for the air layer.

By excluding the model for the housing and the model for the shaft, or the like from the model for the electric motor, the computational complexity for estimating the temperature of the temperature detector or the computational complexity for setting the parameters can be reduced. Although the model for the electric motor according to the present embodiment does not include the model for the housing or the model for the shaft that have a relatively large heat capacity, simulation of the temperature of the temperature detector can be performed with high accuracy, as illustrated in FIG. 9.

In the aforementioned temperature estimator, when the estimation unit estimates the temperature of the temperature detector by using the model for the electric motor, the constant values of the copper loss, the iron loss, the heat transfer-related coefficient, and the heat capacity are used without depending on the temperatures of the components of the electric motor. However, these losses and parameters may change in value as the temperatures of the components of the electric motor change. Next, an example of correcting at least one of the copper loss, the iron loss, the heat transfer-related coefficient, and the heat capacity in the model for the electric motor based on the temperatures of the components of the electric motor, is described. The correction of each parameter is based on a correction value. Here, the model 10a for the first electric motor is taken and described as an example, from among the model 10a for the first electric motor (see FIG. 3) and the model 27a for the second electric motor (see FIG. 6).

First, correction of the iron loss that occurs in the stator core is described. The loss of the electric motor at no load is caused by the iron loss in the stator core. The iron loss is caused by a change in magnetic flux generated in the stator core. Here, when the temperature of the rotor of the electric motor rises, the temperature of the magnet included in the rotor rises. A magnet has the property that its magnetic force weakens as temperature rises. Thus, as the magnet temperature rises, the magnetic flux generated in the stator core decreases. That is, the iron loss decreases as the temperature of the rotor increases.

FIG. 10 illustrates a graph of the correction values for correcting the loss at no load for the rotor temperature. The correction of the iron loss is performed in a manner that the higher the temperature of the rotor, the smaller the iron loss. In the present embodiment, loss at no load is corrected depending on the temperature of the rotor. Referring to FIG. 1, the loss calculating unit 54 of the estimation unit 53 corrects in a manner that the higher the temperature of the rotor rises, the smaller the loss of the electric motor at no load becomes. The loss calculating unit 54 determines a coefficient sn based on the temperature of the rotor. And the loss calculating unit 54 multiplies the loss at no load by the coefficient sn.

In the example illustrated in FIG. 10, the temperature T₄ of the rotor is illustrated from a room temperature of 20° C. to a maximum value of 130° C. When the temperature of the rotor is 20° C., the coefficient sn is 100%, and when the temperature of the rotor is the maximum value, the coefficient sn is snx %. The coefficient snx corresponds to a correction value to make the iron loss smaller as the temperature of the rotor increases. The magnitude of coefficient snx when the rotor temperature is at its maximum depends on characteristics such as shape and material in the rotor core and the magnet. The coefficient snx can be predetermined by the operator. Alternatively, the coefficient snx when the rotor temperature is at its maximum can be set by the parameter setting device as described below.

Referring to FIGS. 1, 3 and 10, the loss calculating unit 54 of the estimation unit 53 calculates the coefficient sn based on the temperature T₄ of the rotor calculated in the model 10a for the electric motor. Table 1 is a loss map illustrating the loss and the current as a reference. Table 1 illustrates, for example, a loss map when the rotor temperature is 20° C. and the coefficient sn is 100%.

The loss calculating unit 54 can calculate the value, which results from multiplying the loss Pₙ at no load acquired from the loss map in Table 1 by the coefficient sn, as the loss at no load after correction. The loss calculating unit 54 calculates the iron loss by using the corrected loss at no load. According to Equation (6), when the rotor temperature rises, the loss Pₙ at no load becomes smaller and the total loss Pₜ becomes smaller. This results in a smaller iron loss Pᵢ by Equation (10). The temperature calculating unit 55 can calculate the temperature of the component including the temperature detector based on the corrected iron loss. Thus, the magnitude of the iron loss, which varies based on the rotor temperature, can be considered.

Note that correction of the iron loss that occurs in the stator core is not limited to the above configuration. The iron loss can be corrected based on the rotor temperature by any method. For example, correction may be performed by multiplying the iron loss calculated for temperature that is a reference of the rotor, by a coefficient based on the rotor temperature.

Next, correction of the primary copper loss generated at the coil will be described. The primary copper loss of an electric motor corresponds to the Joule heat generated at the winding of the stator coil. The primary copper loss is calculated as the product of the primary resistance r1 in the stator coil and the square of the current I, as illustrated in Equation (8). Here, the coil winding has the property that the resistance increases as the temperature increases. Thus, the primary copper loss increases as the coil temperature increases.

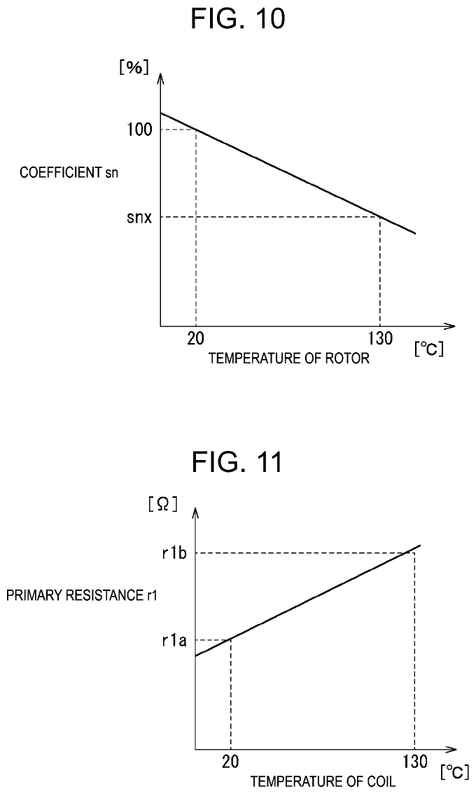

FIG. 11 illustrates a graph of the primary resistance value for the coil temperature. With reference to FIGS. 1, 3 and 11, the correction for the primary copper loss is made in a manner that the higher the coil temperature, the larger the primary copper loss. In the present embodiment, the primary resistance is corrected depending on the coil temperature. The loss calculating unit 54 determines the primary resistance r1 based on the coil temperature. And the loss calculating unit 54 calculates the primary copper loss based on the primary resistance.

In the example illustrated in FIG. 11, a temperature T₁ of the coil is illustrated from a room temperature of 20° C. to a maximum value of 130° C. A primary resistance r1a when the coil temperature is a room temperature, can be measured and determined in advance. In addition, a primary resistance r1b when the coil temperature is the maximum value can be measured and determined in advance. The primary resistances r1a, r1b depend on the material, the shape and the length of coil windings, or the like. Alternatively, the primary resistances r1a, r1b can be set by the parameter setting device as described below. The primary resistances r1a, r1b correspond to the correction values for making the primary copper loss larger as the coil temperature increases.

The loss calculating unit 54 of the estimation unit 53 calculates corrected primary resistance r1 based on the temperature T₁ of the coil calculated in the model 10a for the electric motor. The loss calculating unit 54 calculates the primary copper loss based on Equation (8) by using the corrected primary resistance r1. As the coil temperature rises, the primary copper loss increases because the primary resistance r1 becomes larger. The temperature calculating unit 55 can calculate the temperatures of the components including the temperature detector based on the corrected primary copper loss.

Note that correction of primary copper loss that occurs in the coil is not limited to the above configuration. Any correction method that corrects the primary copper loss based on the coil temperature, can be employed. For example, correction may be performed by multiplying the calculated copper loss by a coefficient based on the coil temperature.

Next, correction of the heat transfer-related coefficients set between the components will be described. The heat transfer coefficient generally has the property that the larger the temperature difference between the components, the larger the heat transfer coefficient becomes. Also, each contact area between the components is constant. Thus, in the correction of the heat transfer-related coefficients, correction can be made in a manner that the larger the temperature difference between the components, the larger the heat transfer-related coefficients.

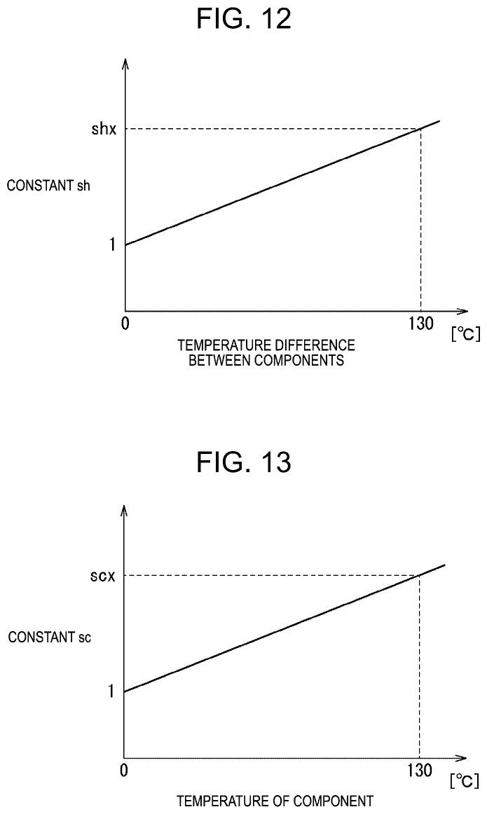

FIG. 12 illustrates a graph of a constant for correcting heat transfer-related coefficient with respect to a temperature difference between the components of the electric motor. The horizontal axis illustrates the temperature difference between the components of the electric motor from a minimum value of 0° C. to a maximum value of 130° C. The vertical axis illustrates a constant sh for correcting the heat transfer-related coefficient that is a reference. The heat transfer-related coefficient that is a reference can be predetermined. Here, the heat transfer-related coefficient when the temperature difference between the components is 0° C. is defined as a heat transfer-related coefficient that is a reference. The constant sh is 1 when the temperature difference between the components is 0° C. When the temperature difference between the components is maximum, the constant sh is shx.

With reference to FIGS. 1, 3, and 12, the temperature calculating unit 55 of the estimation unit 53 calculates a corrected heat transfer-related coefficient h′ by multiplying the heat transfer-related coefficient h as a reference by the coefficient based on the constant sh, as illustrated in the following Equation (16).

$$\begin{matrix}Math . 9 & \\ {h}^{′} = h ( ( shx - 1 ) \frac{( {T}_{a} - {T}_{b} )}{130} + 1 ) & ( 16 )\end{matrix}$$

$${h}^{′} : Corrected heat transfer - related coefficient$$

$$h : Reference heat transfer - related coefficient$$

$$( {T}_{a} - {T}_{b} ) : Temperature Difference between Components$$

Equation (16) sets the corrected heat transfer-related coefficient to the heat transfer-related coefficient as a reference when the temperature difference between the components is 0° C. The constant shx when the temperature difference between the components is maximum corresponds to a correction value that changes the heat transfer-related coefficient according to the temperature difference between the components. In the example illustrated in FIG. 12, the constant shx is greater than 1, and the greater the temperature difference between the components, the greater the coefficient by which the heat transfer-related coefficient as a reference is multiplied. In other words, the constant shx illustrated in FIG. 12 corresponds to a correction value for making the heat transfer-related coefficient larger as the temperature difference between the components increases. The constant shx is, for example, a value greater than 0 and less than about 3. The constant shx may be predetermined. Alternatively, the constant shx can be set by the parameter setting device, as described below.

The temperature calculating unit 55 of the estimation unit 53 calculates the temperature difference between the components. The temperature calculating unit 55 acquires the heat transfer-related coefficient as a reference, between the components. The temperature calculating unit 55 calculates the corrected heat transfer-related coefficient based on Equation (16). The temperature calculating unit 55 calculates the temperature of each component by using the corrected heat transfer-related coefficient.

For example, the temperature calculating unit 55 calculates the temperature difference between the current temperature T₁ of the model for the coil and the current temperature T₂ of the model for the stator core in the model 10a for the electric motor. The heat transfer-related coefficient as a reference, between the coil and the stator core, is predetermined. The temperature calculating unit 55 calculates the corrected heat transfer-related coefficient based on Equation (16). Then, the temperature calculating unit 55 calculates the change amount in the temperature T₁ of the model for the coil for a minute time period and the change amount in the temperature T₂ of the model for the stator core for a minute time period, by using the corrected heat transfer-related coefficients in Equations (1) and (2) above. In this way, the temperature of the component can be calculated by considering the heat transfer-related coefficient, which varies with the temperature difference between the components.

In the above configuration of correcting the heat transfer-related coefficient, correction is made in a manner that the heat transfer-related coefficient increases as the temperature difference between the components increases, but the configuration is not limited to this. When the constant shx as a correction value is calculated in the parameter setting device described later, there are cases where the heat transfer-related coefficient becomes smaller as the temperature difference between the components becomes larger. That is, the constant shx may be less than 1. In this case, the estimation unit can correct the heat transfer-related coefficient in a manner that the larger the temperature difference between the components, the smaller the heat transfer-related coefficient. Thus, the estimation unit can make corrections that change the heat transfer-related coefficient according to the temperature difference between the components.

Next, the correction of the heat capacity of the component will be described. Heat capacity generally has the property of becoming larger as the temperature of the component increases. Thus, the heat capacity of the component can be corrected in a manner that the higher the temperature of the component, the greater the heat capacity.

FIG. 13 illustrates a graph of a constant for correcting heat capacity for the component temperature. The horizontal axis illustrates the temperature of the component of the electric motor from a minimum value of 0° C. to a maximum value of 130° C. The vertical axis illustrates a constant sc for correcting a reference heat capacity. The reference heat capacity may be predetermined. In the example here, the reference heat capacity is the heat capacity when the temperature of the component is 0° C. The constant sc is 1 when the temperature of the component is 0° C. The constant sc when the temperature of the component is maximum is scx.

Referring to FIGS. 1, 3 and 13, the temperature calculating unit 55 of the estimation unit 53 calculates a corrected heat capacity C′ by multiplying the reference heat capacity C by a coefficient based on the constant sc, as illustrated in the following Equation (17):

$$\begin{matrix}Math . 10 & \\ {C}^{′} = C ( ( scx - 1 ) \frac{{T}_{c}}{130} + 1 ) & ( 17 )\end{matrix}$$

$${C}^{′} : Corrected heat capacity$$

$$C : Reference heat capacity$$

$${T}_{c} : Temperature of component$$

Equation (17) sets the corrected heat capacity to the reference heat capacity when the temperature of the component is 0° C. The constant scx when the temperature of the component is maximum corresponds to a correction value that changes the heat capacity according to the temperature of the component. In the example illustrated in FIG. 13, the constant scx is greater than 1, and the higher the temperature of the component, the greater the coefficient by which the reference heat capacity is multiplied. That is, the constant scx illustrated in FIG. 13 corresponds to the correction value for correcting the heat capacity so as to increase as the temperature of the component increases. The constant scx is, for example, a value greater than 0 and less than about 3. The constant scx may be predetermined. Alternatively, the constant scx can be set by the parameter setting device, as described below.

The temperature calculating unit 55 of the estimation unit 53 acquires the temperature and the reference heat capacity of the component. The temperature calculating unit 55 calculates the corrected heat capacity of each component based on Equation (17). The temperature calculating unit 55 can calculate the temperature of each component by using Equations (1) to (5) above and by using the corrected heat capacity. In this way, the temperature of the component can be estimated by considering the heat capacity that varies with the temperature of the component.

Note that, in the above configuration of correcting the heat capacity, correction is made in a manner that the heat capacity increases as the temperature of the component increases, but the configuration is not limited to this. When the constant scx as the correction value is calculated in a parameter setting device described later, there are cases where the heat capacity becomes smaller as the temperature of the component becomes larger. That is, the constant scx may be less than 1. In this case, the estimation unit can correct the heat capacity in a manner that the higher the temperature of the component, the smaller the heat capacity. Thus, the estimation unit can make correction that changes the heat capacity according to the temperature of the component.

The above iron loss correction, the copper loss correction, the heat transfer-related coefficient correction and the heat capacity correction can be made in combination with each other. Or any one of the corrections may be made. Depending on the temperature of each component, at least one of the iron loss, the primary copper loss, the heat transfer-related coefficient, and the heat capacity can be corrected. As a result, the temperature of the temperature detector can be estimated more accurately.

The correction of the secondary copper loss in the model 27a for the second electric motor illustrated in FIG. 6 can be made in the same way as the correction of the primary copper loss. Then, by using the corrected secondary copper loss, the temperature of a temperature detector attached to any component can be calculated.

Thus, in the model for the electric motor, at least one of the heat capacity, the heat transfer-related coefficient, the iron loss, and the copper loss can be corrected based on the correction values. The correction value for correcting the heat capacity or the like can be set in the parameter setting device described above in the same way as setting of the parameters such as the heat capacity and the heat transfer-related coefficient. Similar to the heat capacity and the heat transfer-related coefficient, the correction value can be set in the parameter setting device described above by treating the correction value as an unknown parameter.

Referring to FIG. 1, the parameter setting unit 61 of the temperature estimator 2 can set the correction value by, for example, Bayesian optimization method or the like. The parameter setting unit 61 can calculate the respective correction values in the same way as setting of the heat transfer-related coefficients and the heat capacities. For example, the parameter setting unit 61 sets parameters and correction values such as heat transfer-related coefficient to tentative initial values. The state acquiring unit 62 acquires the driving state of the electric motor. The loss calculating unit 54 of the estimation unit 53 calculates the loss based on the driving state such as rotation speed of the electric motor 10 acquired in the state acquiring unit 62. The temperature calculating unit 55 of the estimation unit 53 estimates the temperature of the model 31a for the temperature detector by using the model for the electric motor based on the loss calculated in the loss calculating unit 54. In this case, the loss and the heat capacity or the like corrected based on the correction value are used.

The evaluation unit 66 of the parameter calculating unit 63 evaluates the temperature of the model 31a for the temperature detector calculated with tentatively set parameters and correction values. The evaluation unit 66 evaluates the temperature of the model 31a for the temperature detector without evaluating variables other than the temperature of the model 31a for the temperature detector. The parameter calculating unit 63 can adopt the current parameters and correction values as long as the temperature of the model 31a for the temperature detector is within the predetermined determination range. For example, the parameter calculating unit 63 can adopt the current parameters and correction values when the difference between the temperature of the model 31a for the temperature detector and the temperature output from the actual temperature detector 31 is small. On the other hand, when the temperature of the model 31a for the temperature detector deviates from the predetermined determination range, the parameter change unit 67 changes the parameters and the correction values based on the evaluation result of the evaluation unit 66. In this way, setting the parameters and the correction values and evaluating the temperature of the model for the temperature detector can be performed repeatedly.

The parameter calculating unit 63 can set the multiple heat capacities and the multiple heat transfer-related coefficients, as well as the correction values. The parameter calculating unit 63 can set the correction values in the same way as a method of setting the heat capacity and the heat transfer-related coefficient. The correction value that is set in the parameter calculating unit 63 may be the same as, or different from the actual correction value. That is, the correction value that is set in the parameter calculating unit 63 may be away from the actual correction value. For example, referring to FIG. 11, the primary resistances r1a, r1b as correction values for calculating primary resistance that varies depending on the coil temperature may have the different value from or the same value as the actual primary resistance. As for the correction value, it is acceptable if the temperature of the temperature detector could be accurately estimated.

The above embodiments can be combined as appropriate. In each of the above drawings, the same or equivalent parts are denoted by the same sign. The above embodiments are examples and do not limit the invention. In addition, the embodiments include modifications of the embodiments provided in the claims.

### REFERENCE SIGNS LIST

2: Temperature estimator
10 Electric motor
10a Model for electric motor
11: Rotor
11a: Model for rotor
12: Stator
16: Coil
16a: Model for coil
20: Stator core
20a: Model for stator core
27a: Model for electric motor
31: Temperature detector
31a: Model for temperature detector
32: Rotational position detector
35a: Model for air layer
43: Operation control unit
54: Loss calculating unit
55: Temperature calculating unit
61: Parameter setting unit
62: State acquiring unit
63: Parameter calculating unit
66: Evaluation unit
67: Parameter change unit

1. A parameter setting device that sets parameters included in a model for an electric motor, the model for an electric motor being configured to estimate a temperature of a temperature detector that detects a temperature of one component constituting the electric motor,
the parameter setting device comprising:
a state acquiring unit configured to acquire an operation command for the electric motor generated by actually driving the electric motor and a temperature output from the temperature detector;
a parameter calculating unit configured to calculate the parameters in a manner that a change in a temperature of a model for the temperature detector calculated by the model for the electric motor corresponds to an actual change in temperature of the temperature detector,
wherein
the model for the electric motor includes a model for a rotor, a model for a stator core, a model for a coil, and the model for the temperature detector, as models for components of the electric motor,
the parameters include a heat capacity that is set for each model for the components and a heat transfer-related coefficient that is set between each two of the models for the components,
the parameter calculating unit includes:
a loss calculating unit configured to calculate a heat generation amount due to a primary copper loss of the coil and a heat generation amount due to an iron loss of the stator core, based on the operation command;
a temperature calculating unit configured to calculate the temperature of the model for the temperature detector by using the model for the electric motor based on the heat generation amount of the coil and the heat generation amount of the stator core;
an evaluation unit configured to evaluate the temperature of the model for the temperature detector by comparing the temperature of the model for the temperature detector with the temperature of the temperature detector acquired by the state acquiring unit; and
a parameter change unit configured to change values of the parameters based on a result of the evaluation by the evaluation unit, and
the evaluation unit evaluates the temperature of the model for the temperature detector without evaluating variables other than the temperature of the model for the temperature detector.

2. The parameter setting device of claim 1, wherein
the parameter calculating unit sets at least some of the parameters of a plurality of the heat capacities and a plurality of the heat transfer-related coefficients to different values from corresponding actual heat capacities or actual heat transfer-related coefficients.

3. The parameter setting device of claim 1, wherein
the state acquiring unit acquires the operation command and the temperature output from the temperature detector during a period when the electric motor is operated to repeat rises and falls of a load factor.

4. The parameter setting device of claim 1, wherein
the state acquiring unit acquires the operation command and the temperature output from the temperature detector during a period when the electric motor is operated to increase gradually a rotation speed at no load.

5. The parameter setting device of claim 1, wherein
the parameter calculating unit calculates the parameters by machine learning in which a difference between the temperature of the model for the temperature detector estimated by the model for the electric motor and an actual temperature detected by the temperature detector is set as an objective function.

6. The parameter setting device of claim 1, wherein
the model for the electric motor is formed in a manner that at least one of the heat capacity, the heat transfer-related coefficient, the iron loss of the stator core, and the primary copper loss of the coil is corrected based on a correction value,
the correction value includes at least one of correction values below:
a correction value configured to correct in a manner to decrease the iron loss as the temperature of the rotor increases;
a correction value configured to correct in a manner to increase the primary copper loss as the temperature of the coil increases;
a correction value configured to correct in a manner to change the heat transfer-related coefficient according to a temperature difference between the components; and
a correction value configured to correct in a manner to change the heat capacity according to the temperature of the component, and
the parameter change unit changes the correction value based on a result of the evaluation by the evaluation unit.
